(19) United States
(12) Patent Application Publication
(10) Pub. No.: US 2015/0242467 A1
(43) Pub. Date: Aug. 27, 2015

(54) PARAMETER BASED MEDIA CATEGORIZATION

(71) Applicant: Google, Inc., Mountain View, CA (US)

(72) Inventors: Brandon Bilinski, San Francisco, CA (US); Alexander Collins, San Francisco, CA (US)

(73) Assignee: Google Inc., Mountain View, CA (US)

(21) Appl. No.: 14/190,432

(22) Filed: Feb. 26, 2014

(51) Int. Cl. G06F 17/30; H04W 64/00

(52) U.S. Cl. CPC G06F 17/30528; H04W 64/006

(57) ABSTRACT

Systems, device and techniques are disclosed for providing a media item using a media recommendation model. The media recommendation model can be configured to identify a media item based on a received parameter from a mobile device by comparing the received parameter with a parameter associated with the media item. A parameter may correspond to a mobile device movement, time, location or the like and may be provided from a sensor such as a position sensor, an accelerometer, a clock, a barometer, or the like.

### BACKGROUND

Traditionally, music recommendations are based either on similarity to other media or recommendations from another user such as a friend or group recommender. As an example, a user may select a first song to listen to and, based on that selected song, a program may select a second song to play for the user after the first song. A user's activity is generally not a factor when determining what media item to provide to the user. Continuing the previous example, a user that selects the first song would be recommended the second song regardless of whether the user was seated or whether the user was moving.

### BRIEF SUMMARY

According to implementations of the disclosed subject matter, a first parameter may be received from a first mobile device sensor and a first media metadata corresponding to an active media item may also be received. A media recommendation model may be generated based at least on the first parameter and the first media metadata. A second parameter from a second mobile device sensor may be received and a determination may be made that the first parameter and the second parameter are similar. Here, the first mobile device sensor and the second mobile device sensor may be the same mobile device sensors. A second media item may be provided using the media recommendation model, based on determining that the first parameter and the second parameter are similar. A parameter may be a mobile device movement, a time, or a location based parameter. A mobile device sensor may be a GPS sensor, an accelerometer, a barometer, or the like.

According to implementations of the disclosed subject matter, a systems and devices for providing a media item may include means for receiving a first parameter from a first mobile device sensor and means for receiving a first media metadata corresponding to an active media item. The system includes means for generating a media recommendation model based on the first parameter and the first media metadata. Means for receiving a second parameter from a second mobile device sensor and for making a determination that the first parameter and the second parameter are similar may be used. Here, the first mobile device sensor and the second media item may be provide mobile device sensor may be the same mobile device sensors. Means for providing a second media item based on the determination that the first parameter and the second parameter are similar may be provided. A parameter may be a mobile device movement, a time, or a location based parameter. A mobile device sensor may be a GPS sensor, an accelerometer, a barometer, or the like.

Systems and techniques according to the present disclosure providing media items based on user activity, location, or time. Additional features, advantages, and implementations of the disclosed subject matter may be set forth or apparent from consideration of the following detailed description, drawings, and claims. Moreover, it is to be understood that both the foregoing summary and the following detailed description include examples and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows a computer according to an implementation of the disclosed subject matter.

FIG. 2 shows a network configuration according to an implementation of the disclosed subject matter.

FIG. 3 shows an example process for providing media items, according to an implementation of the disclosed subject matter.

FIG. 4 shows an example illustration of a mobile phone in motion based on a running movement, according to an implementation of the disclosed subject matter.

FIG. 5 shows an example illustration of a mobile phone in motion based on a car movement, according to an implementation of the disclosed subject matter.

### DETAILED DESCRIPTION

Techniques disclosed herein may enable providing one or more users with media content (e.g., music, video clips, etc., as disclosed herein) based on a current state of a user (e.g., running, driving, waking up, falling asleep, etc.). The provided media content may be selected based on data gathered during the same or similar state of a user (may be a different user than the user being provided the media item). As an example, a user may select a song A while running Data associated with both running and the song may be used to generate a media recommendation model. A media recommendation model may include a collection of associations between parameters and media items. The associations may be made using one or more parameters and the media metadata associated with one or more media items. Subsequently, when a detection is made that the user is running, the media recommendation model may provide the user with the same song or similar song automatically. Essentially, the media recommendation model may be used to provide media items to users based on data that correlates user's state and media preferences. As another example, a user may listen to instrumental music while driving. The user's mobile phone may provide information corresponding the user traveling at driving speeds and listening to instrumental music. A media recommendation model may be generated and may include an association between the user driving and listening to instrumental music. Subsequently, when it is detected that the user is most likely driving, the user may automatically be provided with instrumental music.

A mobile device may be configured to detect or generate signals based on a user's state. Signals from mobile devices may include movement based signals, time based signals, location based signals, or the like. As an example of a movement based signal, a user may place her mobile phone in a pocket and may go for a run while the mobile phone is in the user's pocket. The mobile phone may contain sensors that detect speed and acceleration such that the signal provided by the mobile phone may be analyzed and it may be determined that the user is running based on the speed and acceleration signal. As an example of a time based system, a user's mobile phone may contain a time sensor and, thus, analysis of the signal provided by the time sensor may provide time information. As an example of a location based signal, a user may be in an airplane, with her tablet computer, and flying from England to Paris. A location based sensor within the tablet computer may provide a signal and the signal may be analyzed to determine the user's current location as well as the user's trajectory. Techniques described herein enable generation of a media recommendation model that associates media items with one or more parameters. As an example, a user may prefer to listen to jazz music while the user is driving and the media recommendation model may learn this preference by associating the music played by the user while the user's phone indicates that the user is moving at driving speeds. Accordingly, once the media recommendation model has learned the user's preference, when the user's phone subsequently provides an indication that the user is driving, the user may automatically be provided with jazz music.

According to implementations of the disclosed subject matter, one or more parameters may be received from a mobile device. A parameter may correspond to a movement, a time, a location, or a combination thereof As an example, a user's speed, while the user is running, may be received based on a GPS or other position sensor located in the mobile device. Additionally, media metadata corresponding to an active media item may be received. An active media item may be a media item (e.g., a song) that a user is currently exposed to (e.g., via headphones). As an example, a user may be listening to Michael Jackson's “Thriller” and, thus, a song identifier (i.e., media metadata) corresponding to the song “Thriller” may be received. Based on the parameter and the media metadata, a media recommendation model may be generated (e.g., created, modified, etc.). The media recommendation model may associate the media metadata with at least the parameter. Continuing the previous examples, according to the media recommendation model, a user's speed, while running, may be associated with the song “Thriller”. Subsequently, another parameter that is similar to the initial parameter may be received from a mobile device. As an example, a mobile phone may provide a user's speed while the user is running The mobile device may be the same as the initial mobile device or may be a different mobile device. The current parameter may be similar to the initial parameter based on the factors disclosed herein such as a parameter value within a certain range of the initial parameter (e.g., within 2 mph). Based on the similarity of the parameters, the media recommendation model may provide a media item to the user. Here, the media item may be the same as or similar to the media item that the media recommendation model was generated based on. As an example, if a first parameter is 6 mph and a song that a user is listening to when the parameter is recorded (i.e., while moving at 6 mph) is “Thriller”, then, subsequently, the media recommendation model may recommend the song “Thriller” when a parameter of moving at 6 mph is received.

It will be understood that the disclosed one or more parameters may be received at an entity such as a local server, a cloud server, database, computer, or the like and the entity may be external to a mobile device that provides the parameter or may be contained within the mobile device that provides the parameter. As an example of the entity contained within the mobile device, a mobile phone GPS sensor may record a user's location and/or speed and provide it to a processor located within the mobile phone. The processor may initiate communication with a remote server hosting a media recommendation model and may receive a media item from the server, based on the GPS reading.

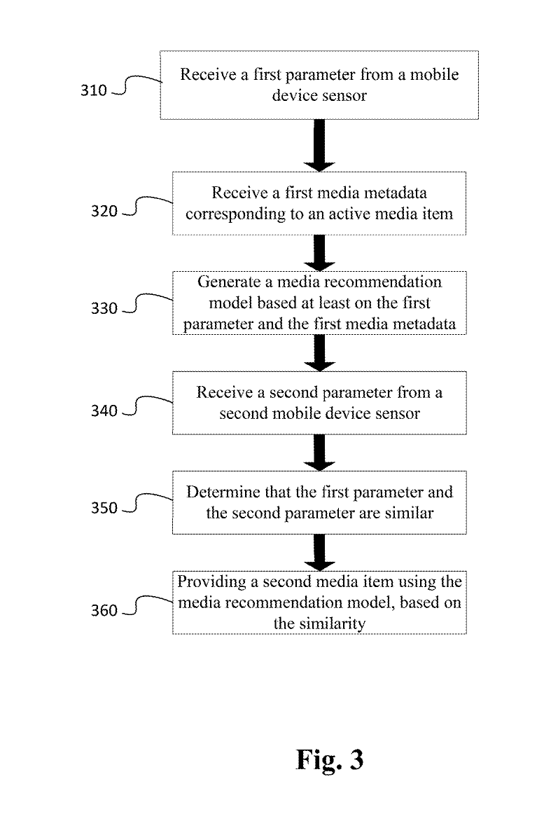

According to an implementation of the disclosed subject matter, as shown in FIG. 3 at step 310, a first parameter from a mobile device sensor may be received. The parameter may be any applicable indication such as a movement, a time, a temperature, a location, or the like and may be expressed as a magnitude, a degree, a speed, a range, a change in an indication, or the like. A mobile device sensor may be a sensor that is associated with a mobile device and may be a position sensor, an accelerometer, a thermometer, a clock, a barometer, or the like. As an example of receiving a first parameter from a mobile device sensor, a mobile phone may contain an accelerometer configured to measure a proper acceleration (i.e., physical acceleration experienced by an object). The accelerometer may detect that the mobile device is cyclically accelerating in an upward direction and then a downward direction. The cyclical acceleration may be a result of a user running while the mobile device is on the user's person. The accelerometer may provide the respective parameter (e.g., the cyclical acceleration) to any applicable entity such as a memory or processor on the mobile device or to an external entity, as disclosed herein.

According to an implementation of the disclosed subject matter, as shown at step 320, a first media metadata corresponding to an active media item may be received. A media item may be a video (video clip, movie, commercial, documentary, music video, etc.), an audio (song, a text, an image or graphic, or the like. Media metadata may correspond to any data indicative or representative of a media item. Media metadata may be a media ID (e.g., numerical ID, string value, hash value, encrypted ID, etc.), a media designator (e.g., title, artists, album, movie, etc.), media characteristic (e.g., tempo, beat, rhythm, genre, length, quality, etc.), or the like. As an example, metadata for the song “Thriller” may be one or more of a media ID (e.g., SongID:232234), a media designator (e.g., Michael Jackson), or a media characteristic (e.g., Pop). An active media item maybe a media item that a user is exposed to while the first parameter of step 310 is received. As an example, the first parameter may correspond to a user's speed of 6 mph and may be received while the user is running. The user may be listening to the song “Thriller” while running and while the first parameter is received. Accordingly, the song “Thriller” would be an active media item for the parameter received at step 310.

According to an implementation of the disclosed subject matter, as shown at step 330, a first media recommendation model may be generated based on at least the first parameter and the first media metadata. The media recommendation model may be a model that recommends media items to a user. A media recommendation model may include a collection (i.e., one or more) of associations between parameters and media items. The association may be made by relating one or more parameters with one or more media metadata such that the presence of the one or more parameters results in providing the one or more associated media items. As an example, a media recommendation model may associate a parameter for moving at 60 mph with alternative rock music. Alternatively or in addition, a media recommendation model may associate moving at 60 mph with driving, and may further associate one or more media items with driving. The media recommendation model may be generated (i.e., created, updated, etc.) such that the media recommendation model associates at least the first parameter with the first media metadata. The association may be any applicable link between the first parameter and first media metadata and may include associating the first parameter with the media item associated with the media metadata, the first parameter with a designator associated with the media metadata (e.g., an artist, album, movie, etc.), the first parameter with a characteristic associated with the media metadata (e.g., tempo, beat, rhythm, genre, length, quality, etc.), or the like. As an example, a first parameter may correspond to a mobile phone moving at 60 mph, without any directional acceleration. This parameter may correspond to a user driving. Additionally, the user may be playing the song “Driving” while the first parameter of moving at 60 mph, without any directional acceleration, is recorded. Accordingly a media recommendation model may be updated to associate the song “Driving” with the parameter of moving at 60 mph, without any directional acceleration. As another example, a first parameter may correspond to a time of 6:30 AM and the user may be listening to the song “Morning” that has a very fast tempo. Accordingly, a media recommendation model may be updated to associate fast tempos with the parameter of the time 6:30 AM.

According to an implementation of the disclosed subject matter, a threshold amount of instances of a parameter-metadata combination may be required before associating a parameter with metadata. As an example, the first time the song “Driving” is received along with the parameter corresponding to moving at 60 mph, without any directional acceleration, the media recommendation model may not associate the song “Driving” with the parameter of moving at 60 mph, without any directional acceleration. However, if the association threshold is 3, then the third time that the song “Driving” is received along with the parameter corresponding to moving at 60 mph, without any directional acceleration, the song “Driving” will be associated with the parameter.

According to an implementation of the disclosed subject matter, as shown at step 340, a second parameter may be received from a second mobile device sensor. The second mobile device sensor may be the same device sensor as the first mobile device sensor, providing a parameter at a time that is subsequent to the mobile device sensor providing the first parameter. As an example, an accelerometer on a user's mobile phone may provide a relative acceleration X while a user is running in the morning. As disclosed herein, media metadata for a media item active while the user is running may be used to generate a media recommendation model. Subsequently, the same mobile phone may provide a relative acceleration X while a user is running in the evening. As disclosed herein, the user may be provided a media item on the generated media recommendation model.

Alternatively, the second mobile device sensor may be a different device sensor as the first mobile device sensor. Here, the second mobile device sensor may be a sensor that is similar to the first mobile device sensor, however, may be contained within a different mobile device as the first mobile device sensor. As an example, an accelerometer on a user's mobile phone may provide a relative acceleration X while a user is running in the morning. As disclosed herein, media metadata for a media item active while the user is running may be used to generate a media recommendation model. Subsequently, a different mobile phone may provide a relative acceleration X while a different user is running in the evening. As disclosed herein, the different user may be provided a media item on the generated media recommendation model. Here, the parameter from a first mobile device sensor as well as the media metadata and/or a media recommendation model may provide to and/or stored at a remote server such that multiple mobile devices have access to the media recommendation model located at the remote server.

According to an implementation of the disclosed subject matter, as shown at step 350 in FIG. 3, a determination may be made that a first parameter and a second parameter are similar. A similarity between parameters may indicate that the activity being performed when a first parameter is collected is similar to an activity when a second parameter is collected. As an example, the parameters provided by a mobile device while a user is running may be the same when the user runs at a first time vs when the user runs at a second time. The similarity between parameters may be based on any applicable factor such as the same or similar value, speed, acceleration, magnitude, angle, degree, or the like. The similarity may be based on a range, percentage, ratio or the like. As an example, a first parameter may be 60 mph a parameter similar to the first parameter may be one that is within 10% of the first parameter such that a second parameter that is between 54 mph and 66 mph may be similar to the first parameter. Two or more parameters may be similar if they meet a predetermined or dynamically determined criteria that qualifies parameters as similar. A predetermined criteria may be set by a developer, user, device, or the like. As an example, a developer may provide a deviation value of 5% such that parameters with values within 5% of each other are considered similar. Further, the similarity may factor in the type of parameter such that, for example, a speed may be compared to a speed and an acceleration may be compared to a parameter. For example, a first parameter includes a 5 mph speed and an oscillating acceleration, up then down. A second parameter may be considered similar to the first parameter if it includes a 6 mph speed and an oscillating acceleration, up then down. A second parameter may not be considered similar to the first parameter if it includes a 5 mph speed and no oscillating acceleration. It will be understood that parameters received from different sensors may still be similar. As an example, the thermometer in a first mobile phone may provide a temperature reading of 89 degrees and the thermometer in a second mobile phone may provide a temperature reading of 87 degrees. Both temperatures may be similar based on a predetermined rule that temperatures within 5 degrees of each other are similar.

According to an implementation of the disclosed subject matter, as shown at step 360 in FIG. 3, a second media item may be provided based on the similarity between a first parameter and a second parameter. As disclosed herein, a similarity between parameters may indicate that the activity being performed when a first parameter is collected is similar to an activity when a second parameter is collected. The second media item may be the same as the first media item. For example, a user may select the song Purple, by selecting it on a mobile phone via the mobile phone's touch screen, while jogging in the morning. A media recommendation model may be generated associating jogging and the song Purple. Subsequently, the user may go for a jog and may automatically be provided with the song Purple. Alternatively, the second media item may be related to the first media item such that a user that opts to be exposed to the first media item during an activity is likely to benefit from being exposed to the second media item during the same/similar activity. Essentially, the second media item may be a media item that the user enjoys during the same/similar activity. As an example of a provided second media item, a user may elect to listen to a techno song while running The parameters associated with the run as well as media metadata for the techno song may be used to generate a media recommendation model. Subsequently, similar parameters may be received and, using the media recommendation model, a techno song by the same artist as the initial techno song may be provided to the user. A similarity between parameters may be determined based on a threshold similarity value. A threshold similarity value may be predetermined or dynamically determined and may be based on a parameter, type of parameter, sensor, user, preference, setting, or the like. A first parameter may be similar to a second parameter if a value associated with the second parameter is within the threshold similarity value of the first parameter. A threshold similarity value may be a percentage or a ratio. As an example, a first parameter may correspond to an acceleration of 2 mph/second and if the threshold similarity value is 25% then a second parameter corresponding to an acceleration of 2.2 mph/second (i.e., 10%) is similar to the first parameter. Alternatively or in addition, a threshold similarity value may be a range and may be associated with an activity. As an example, a speed that is between 12 and 90 mph may be associated with driving and thus two parameters that contain speeds within that range be within the threshold similarity value of each other.

A second media item may be selected based on any applicable relation to the first media item such as metadata similarity (e.g., mediaID, media characteristic, media designator, etc.). Examples of criteria for selection of a second media item can include same or similar artist, genre, tempo, lyrics, etc. As a specific example, a media item may be a standup comedy video clip by Conan O'Brien and a media item that is similar may be determined based on the category (i.e., standup comedy) and maturity level of the content (i.e., adult). Accordingly, a standup comedy clip by Jay Leno may be provided as a second media item.

According to an implementation of the disclosed subject matter, a first parameter may correspond to a category and a second parameter may be similar to the first parameter based on the same or similar categories. As an example, a GPS sensor on a user's mobile device may provide GPS coordinates for the mobile device. The GPS coordinates may be associated with a location such as, for example, a café, a museum, a home, an office, a gym, a track, or the like. As disclosed herein, upon detection of a second parameter that is the same as or similar to a first parameter, a media item may be provided to a user. According to this implementation, the similarity between the location based first parameter and the location based second parameter may be that the category corresponding to the first parameter is the same category as the location corresponding to the second parameter. A category may be a type of location, activity, time, or the like. Specific examples of location categories can include cafes, museums, homes, schools offices, gyms, tracks, highways, or the like. Specific examples of activities can include running, jogging, walking, sitting, traveling, participating in a sport, or the like. Specific examples of time may be early morning, breakfast, afternoon, lunch, evening, dinner, night, or the like. As an example, a user may select a jazz song to play while the user is located in a café. The GPS coordinates for the café as well as the metadata for the jazz song may be received and a media recommendation model may associate the media metadata with cafes. Accordingly, it may be determined that jazz songs may be provided to users in cafes. It will be understood that additional parameters may be incorporated into a media recommendation model. For example, individualized recommendations may be provided such that only users that have selected jazz music in a café will be provided jazz music automatically.

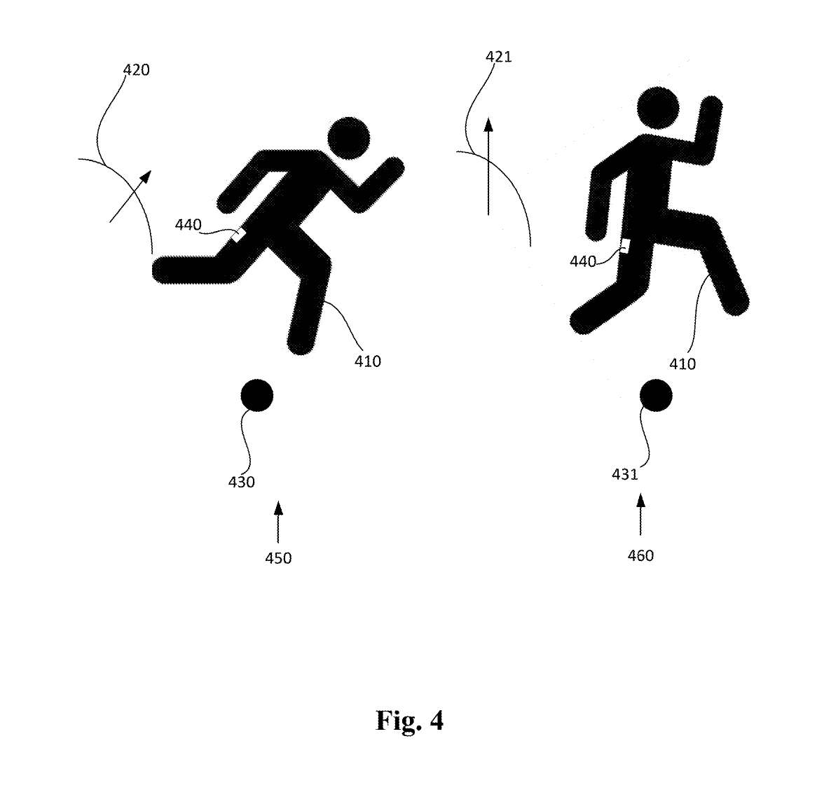

As an illustrative example of the disclosed subject matter, as shown in FIG. 4, a mobile device 440 secured to a person 410 may contain a GPS sensor as well as an accelerometer. As the person 410 is running, the GPS sensor may provide the mobile phone 440's location and the accelerometer may provide a magnitude and direction for an acceleration for the mobile phone 440. At a first time 450, the GPS sensor may provide location 430 and the accelerometer may record an acceleration in the direction indicated by the meter 420. At a second time 460, the GPS sensor may provide location 431 and the accelerometer may record an acceleration in the direction indicated by meter 420. The change in GPS coordinates may indicate a speed and the change in acceleration direction may indicate a movement. The respective parameter corresponding to the speed and movement may be provided and a media recommendation model may associate the parameter with a heavy metal song that user listened to while the GPS sensor and accelerometer provided the data. The media recommendation model may store the association at a cloud server. Subsequently, the media recommendation model (either local to a user device or a remote location such as a cloud server) may receive a parameter similar to that provided by the GPS sensor and accelerometer. Accordingly, based on the similarity of the newly received parameter to the previously associated parameter, the user device which provided the newly received parameter may be provided with a heavy metal song. Here, as the original parameter is similar to the new parameter it is likely that the users associated with the parameters are in the same state (i.e., running, in this example). Accordingly, providing the heavy metal song may be appropriate based on the previously collected data indicating that heavy metal songs match with running.

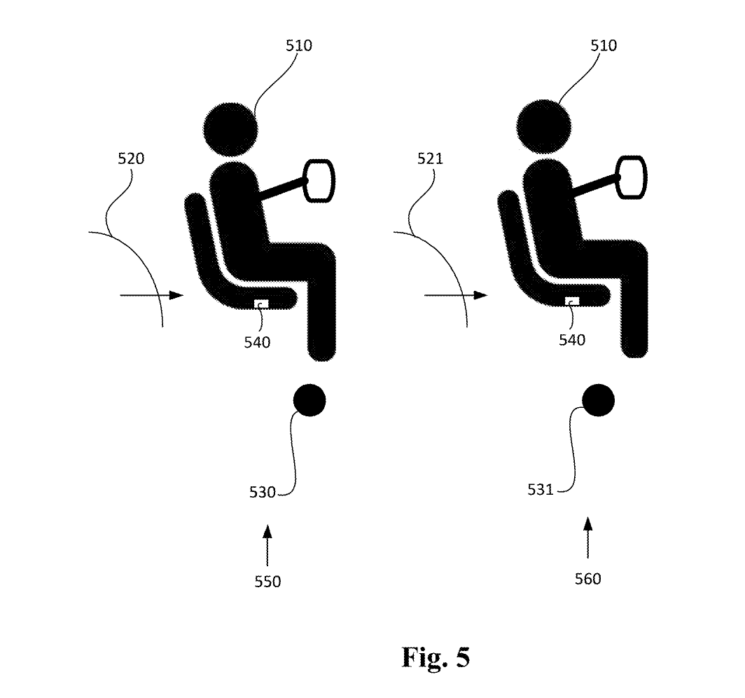

As another illustrative example of the disclosed subject matter, as shown in FIG. 5, a mobile device 540 secured to a person 510 may contain a GPS sensor as well as an accelerometer. As the person 510 is driving, the GPS sensor may provide the mobile phone 540's location and the accelerometer may provide a magnitude and direction for an acceleration for the mobile phone 540. At a first time 550, the GPS sensor may provide location 530 and the accelerometer may record an acceleration in the direction indicated by the meter 520. At a second time 560, the GPS sensor may provide location 531 and the accelerometer may record an acceleration in the direction indicated by meter 520. As shown, the direction of the acceleration may remain the same as the user is driving on a substantially flat road. The change in GPS coordinates may indicate a driving speed and the lack in change in acceleration direction may indicate a linear movement. The respective parameter corresponding to the speed and linear movement may be provided and a media recommendation model may associate the parameter with an alternative rock song that user listened to while the GPS sensor and accelerometer provided the data. The media recommendation model may store the association locally at the mobile device 540. Subsequently, the media recommendation mode may receive a parameter similar to that provided by the GPS sensor and accelerometer. The same mobile device 540 and respective sensors may provide this data. Accordingly, based on the similarity of the newly received parameter to the previously associated parameter, the user device 540 may be provided with the same alternative rock song. Here, as the original parameter is similar to the new parameter it is likely that the user associated with the parameters are in the same state (i.e., driving, in this example). Accordingly, providing the alternative rock song may be appropriate based on the previously collected data indicating that heavy metal songs match with running

According to implementations of the disclosed subject matter, the second media item provided to a user may be in the form of a playlist. A playlist may contain multiple media items and the media items may be related to each other, to the state of a user (e.g., an activity, location, time, or the like, associated with a user), or the like.

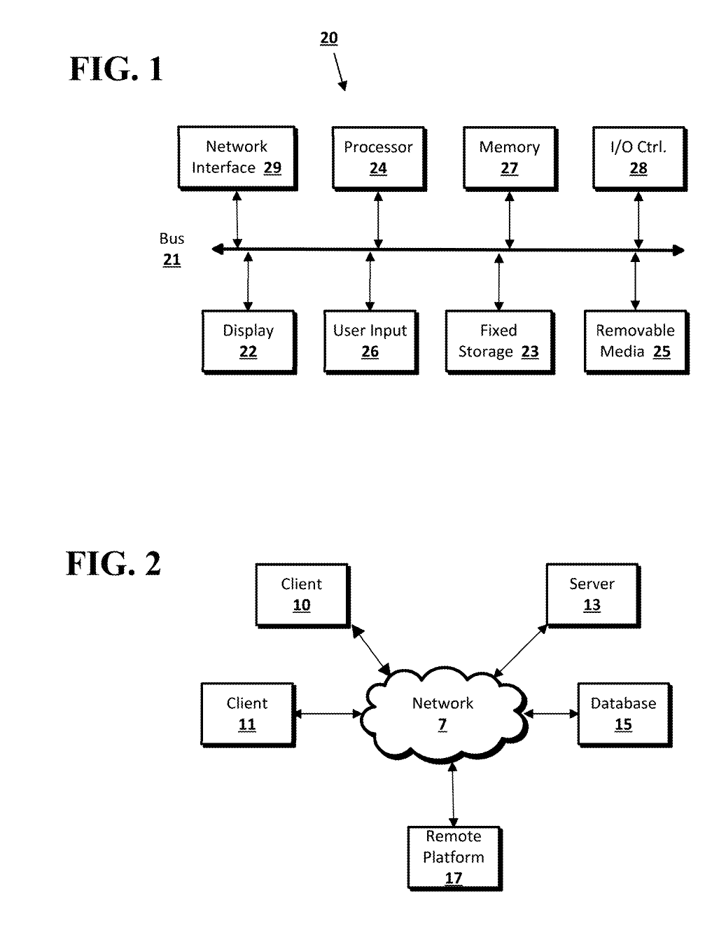

Implementations of the presently disclosed subject matter may be implemented in and used with a variety of component and network architectures. FIG. 1 is an example computer 20 suitable for implementing implementations of the presently disclosed subject matter. A mobile device containing one or more sensors may contain a computer. Alternatively, any device disclosed herein configured to electronically transport, generate, or modify data or information may utilize a computer. The computer (e.g., microcomputer) 20 includes a bus 21 which interconnects major components of the computer 20, such as a central processor 24, a memory 27 (typically RAM, but which may also include ROM, flash RAM, or the like), an input/output controller 28, a user display 22, such as a display or touch screen via a display adapter, a user input interface 26, which may include one or more controllers and associated user input or devices such as a keyboard, mouse, WiFi/cellular radios, touchscreen, microphone/speakers and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 allows data communication between the central processor 24 and the memory 27, which may include read-only memory (ROM) or flash memory (neither shown), and random access memory (RAM) (not shown), as previously noted. The RAM can include the main memory into which the operating system and application programs are loaded. The ROM or flash memory can contain, among other code, the Basic Input-Output system (BIOS) which controls basic hardware operation such as the interaction with peripheral components. Applications resident with the computer 20 can be stored on and accessed via a computer readable medium, such as a hard disk drive (e.g., fixed storage 23), an optical drive, floppy disk, or other storage medium 25.

The fixed storage 23 may be integral with the computer 20 or may be separate and accessed through other interfaces. A network interface 29 may provide a direct connection to a remote server via a telephone link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may allow the computer to communicate with other computers via one or more local, wide-area, or other networks, as shown in FIG. 2.

Many other devices or components (not shown) may be connected in a similar manner (e.g., document scanners, digital cameras and so on). Conversely, all of the components shown in FIG. 1 need not be present to practice the present disclosure. The components can be interconnected in different ways from that shown. The operation of a computer such as that shown in FIG. 1 is readily known in the art and is not discussed in detail in this application. Code to implement the present disclosure can be stored in computer-readable storage media such as one or more of the memory 27, fixed storage 23, removable media 25, or on a remote storage location.

FIG. 2 shows an example network arrangement according to an implementation of the disclosed subject matter. One or more clients 10, 11, such as smart power devices, microcomputers, local computers, smart phones, tablet computing devices, and the like may connect to other devices via one or more networks 7 (e.g., a power distribution network). The network may be a local network, wide-area network, the Internet, or any other suitable communication network or networks, and may be implemented on any suitable platform including wired and/or wireless networks. The clients may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15.

More generally, various implementations of the presently disclosed subject matter may include or be implemented in the form of computer-implemented processes and apparatuses for practicing those processes. Implementations also may be implemented in the form of a computer program product having computer program code containing instructions implemented in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general purpose microprocessor and/or an Application Specific Integrated Circuit (ASIC) that implements all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A method comprising:
receiving a first parameter from a first mobile device sensor;
receiving a first media metadata corresponding to an active media item;
generating a media recommendation model based at least on the first parameter and the first media metadata;
receiving a second parameter from a second mobile device sensor;
determining that the first parameter and the second parameter are similar; and
providing a second media item using the media recommendation model, based on determining that the first parameter and the second parameter are similar.

2. The method of claim 1, wherein the media recommendation model comprises at least a first association between a parameter and a media item.

3. The method of claim 1, wherein the first parameter corresponds to a mobile device movement.

4. The method of claim 1, wherein a parameter corresponds to a time.

5. The method of claim 1, wherein a parameter corresponds to a location.

6. The method of claim 5, wherein the first parameter comprises a first location in a first category and the second parameter comprises a second location in the first category, and wherein the second media item is recommended based on the first and second locations being in the same category.

7. The method of claim 1, wherein the first parameter and the second parameter are similar if they are in the same category.

8. The method of claim 1, wherein the first mobile device sensor is one selected from the group consisting of: a position sensor, an accelerometer, a thermometer, a clock, and a barometer.

9. The method of claim 1, wherein the first media metadata is one selected from the group consisting of: an artist, an album, a genre, a tempo, and a rhythm.

10. The method of claim 1, wherein the active media item is selected from the group consisting of: an audio, a video, and a text.

11. The method of claim 1, wherein the active media item is a currently playing media item.

12. The method of claim 1, wherein the media recommendation model associates at least the first parameter with the first media metadata.

13. The method of claim 1, wherein the media recommendation model associates at least the first parameter with one or more media items that have media metadata similar to the first media metadata.

14. The method of claim 1, wherein the media recommendation model associates the second media item with the first parameter.

15. The method of claim 1, wherein the second mobile device sensor is the same as the first mobile device sensor.

16. The method of claim 1, wherein the similarity between the first parameter and the second parameter is determined based on a threshold similarity value.

17. The method of claim 1, wherein the first media item and the second media item are the same media item.

18. The method of claim 13, wherein the second media item contains metadata similar to the first media metadata.

19. A system comprising:
a first processor configured to:
receive a first parameter from a first mobile device sensor;
receive a first media metadata corresponding to an active media item; a second processor configured to:
generate a media recommendation model based at least on the first parameter and the first media metadata;
a third processor configured to:
receive a second parameter from a second mobile device sensor;
determine that the first parameter and the second parameter are similar; and
provide a second media item using the media recommendation model, based on determining that the first parameter and the second parameter are similar.

20. The system of claim 19, wherein the media recommendation model comprises at least a first association between a parameter and a media item.

21. The system of claim 19, wherein the first processor and the second processor are the same processor.

22. The system of claim 19, wherein the first processor and the third processor are the same processor.

23. The system of claim 19, wherein a parameter corresponds to a mobile device movement.

24. The system of claim 19, wherein a parameter corresponds to a time.

25. The system of claim 19, wherein a parameter corresponds to a location.

26. The system of claim 25, wherein the second media item is recommended based on a first location corresponding to the first parameter being the same category of location as a second location corresponding to the second parameter.

27. The system of claim 19, wherein the first parameter and the second parameter are similar if they correspond to the same category.

28. The system of claim 19, wherein the mobile device sensor is one selected from the group consisting of: a GPS sensor, an accelerometer, a thermometer, a clock, and a barometer.

29. The system of claim 19, wherein the first media metadata is one selected from the group consisting of: an artist, an album, a genre, a tempo, and a rhythm.

30. The system of claim 19, wherein the active media item is selected from the group consisting of: an audio, a video, and a text.

31. The system of claim 19, wherein the active media item is a currently playing media item.

32. The system of claim 19, wherein the media recommendation model associates at least the first parameter with the first media metadata.

33. The system of claim 19, wherein the media recommendation model associates at least the first parameter with one or more media items that have media metadata similar to the first media metadata.

34. The system of claim 19, wherein the media recommendation model associates the second media item with the first parameter.

35. The system of claim 19, wherein the second mobile device sensor is the same as the first mobile device sensor.

36. The system of claim 19, wherein the similarity between the first parameter and the second parameter is determined based on a threshold similarity value.

37. The system of claim 19, wherein the first media item and the second media item are the same media item.

38. The method of claim 33, wherein the second media item contains metadata similar to the first media metadata.
